(19) United States
(12) Patent Application Publication
(10) Pub. No.: US 2024/0159332 A1
(43) Pub. Date: May 16, 2024

(54) High-pressure hose of pressure washer and pressure washer

(71) Applicant: Greenworks (Jiangsu) Co., Ltd., Changzhou (CN)

(72) Inventor: Kaihong TANG, Changzhou (CN)

(73) Assignee: Greenworks (Jiangsu) Co., Ltd., Changzhou (CN)

(21) Appl. No.: 18/503,149

(22) Filed: Nov. 6, 2023

(30) Foreign Application Priority Data
Nov. 11, 2022 (CN) 202223000000.0

(51) Int. Cl. F16L 11/08

(52) U.S. Cl. CPC F16L 11/085; F16L 11/088

(57) ABSTRACT

The disclosure provides a high-pressure hose of a pressure washer and a pressure washer. The high-pressure hose of a pressure washer includes an inner hose, an outer hose and an interlayer. The inner hose defines a fluid flow passage. The outer hose covers the inner hose. And the interlayer is arranged between the inner hose and the outer hose. The interlayer at least includes a braided layer. The braided layer is provided with by a latticework of interwoven yarn to be a cylindrical structure, and covers an outer wall of the inner hose. The high-pressure hose of the disclosure has both good pressure-bearing performance and good softness, which improves a user's experience.

### CROSS REFERENCE TO RELATED APPLICATION

The present application claims the priority of the following Chinese patent application: serial No. 202223000000.0, filed Nov. 11, 2022; the disclosure of which is hereby incorporated by reference herein in its entirety for all purposes.

### TECHNICAL FIELD

The disclosure relates to a field of garden irrigation and pressure washers, in particular to a high-pressure hose of a pressure washer and a pressure washer.

### BACKGROUND

Pressure washers are one of the important equipment for garden maintenance. They are mainly used to irrigate the garden. They may regularly and quantitatively increase soil moisture and air humidity, and adjust local microclimate. The pressure washer is provided with a high-pressure hose, but the conventional high-pressure hose cannot take into account both flexibility and blast resistance at the same time. For example, when ensuring that the conventional high-pressure hose has good blast resistance, the hose body of the high-pressure hose will be relatively hard. The High-pressure hose generates a torque when they twist. When the hose body is hard, damage to the hose body may easily occur after a long-term use. Moreover, when the hose body of the high-pressure hose becomes hard, it will bring safety risks to the user during operation. Therefore, there are areas for improvement in the conventional high-pressure hoses.

### SUMMARY

The disclosure provides a high-pressure hose of a pressure washer, which is used to solve a problem that a hose body of a high-pressure hose is relatively hard, and following technical solutions may be proposed.

The disclosure provides the high-pressure hose of the pressure washer, the high-pressure hose of the pressure washer includes an inner hose, an outer hose and an interlayer. The inner hose defines a fluid flow passage. The outer hose covers the inner hose. The interlayer is arranged between the inner hose and the outer hose, the interlayer at least includes a braided layer, the braided layer is provided with a latticework of interwoven yarn to be a cylindrical structure to cover an outer wall of the inner hose.

In an embodiment of the disclosure, the interwoven yarn intersect with each other to form an angle, and the angle is from 60° to 90°.

In an embodiment of the disclosure, the interwoven yarn in the braided layer intersect with each other to form a ring body, and the cylindrical surface of the ring body is a continuous curved surface.

In an embodiment of the disclosure, the interlayer further comprises at least two strands of reinforcing yarn, and the two strands of reinforcing yarn are centrally symmetrically arranged along a longitudinal axis of the inner hose.

In an embodiment of the disclosure, the interlayer is fixedly connected with the inner hose and the outer hose respectively.

In an embodiment of the disclosure, the inner hose and the outer hose are made of PVC, and the braided layer is made of high-strength polyester industrial filament.

In an embodiment of the disclosure, a diameter of the braided layer is defined as y3, a diameter of the inner hose is defined as y1, and a diameter of the outer hose is defined as y2, wherein, 3.3 mm≤y1<10.5 mm, 3.3 mm<y2≤10.5 mm, and y1<y3<y2.

In an embodiment of the disclosure, the high-pressure hose of a pressure washer further includes a high-pressure hose connector, a nut sleeve clamping component and a nut sleeve. The high-pressure hose connector is connected to two ends of the outer hose. The nut sleeve clamping component is sleeved on an outer wall of the high-pressure hose connector. The nut sleeve is sleeved on the nut sleeve clamping component and an outer wall of the outer hose.

In an embodiment of the disclosure, the high-pressure hose of the pressure washer further comprises at least two straps, and wherein the straps are connected to the outer hose.

The disclosure further provides a pressure washer. The pressure washer includes a power assembly, at least two high-pressure hoses, a working head and a nozzle. The power assembly is provided with an input port and an output port. The at least two high-pressure hoses are respectively connected with the input port and output port of the power assembly. Each high-pressure hose includes the inner hose, an outer hose and an interlayer. The interlayer is arranged between the inner hose and the outer hose, the interlayer at least includes a braided layer and being sleeved on an outer wall of the inner hose, and the braided layer includes at least two braided yarn. The outer hose is sleeved on an outer wall of the braided layer, the two braided yarn are spiral-shaped and rotate in opposite directions, and the two interwoven yarn are configured to intersect with each other to form a circular cylinder network structure and cover the outer wall of the inner hose. The working head is connected with the high-pressure hose which is connected with the output port. The nozzle is connected with the working head.

As mentioned above, the high-pressure hose of the pressure washer of the disclosure has following beneficial effects: the high-pressure hose of the disclosure has both good pressure-bearing performance and good softness, which improves a user's experience.

### BRIEF DESCRIPTION OF THE DRAWINGS

FIG. 1 is a cross-sectional schematic view of a high-pressure hose of a pressure washer of the disclosure.

FIG. 2 is a perspective schematic view of the high-pressure hose of the pressure washer of the disclosure.

FIG. 3 is a structural schematic view of the high-pressure hose of the pressure washer of the disclosure.

FIG. 4 is a front schematic view of the high-pressure hose of the pressure washer of the disclosure.

FIG. 5 is a schematic structural view of the pressure washer of the disclosure.

FIG. 6 is a schematic view of a use of the pressure washer of the disclosure.

### PART NUMBER DESCRIPTION

10—inner hose; 20—interlayer; 21—braided layer; 22—reinforcing yarn; 30—outer hose; 40—glue; 50—protective sleeve; 60—nut sleeve; 70—nut sleeve clamping component; 80—high-pressure hose connector; 90—sealing ring; 100—strap; 110—high-pressure hose; 120—power assembly; 121—tow hook; 122—trolley structure; 130—working head; 131—external thread port; 140—nozzle.

### DETAILED DESCRIPTION

The following describes the implementation of the disclosure through specific embodiments, and those skilled in the art can easily understand other advantages and effects of the disclosure from the content disclosed in this specification. The disclosure may also be implemented or applied through other different specific embodiments. Various details in this specification may also be modified or changed based on different viewpoints and applications without departing from the disclosure. It should be noted that, the following embodiments and the features in the embodiments can be combined with each other without conflict. It should further be understood that the terms used in the examples of the disclosure are used to describe specific embodiments, instead of limiting the protection scope of the disclosure. The test methods that do not indicate specific conditions in the following examples are usually in accordance with conventional conditions, or conditions recommended by each manufacturer.

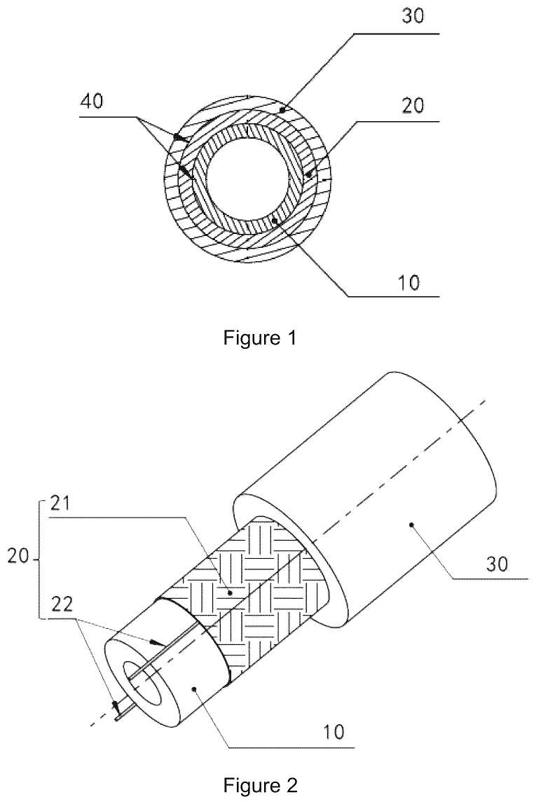

Please refer to FIG. 1 through FIG. 4. It should be noted that structures, proportions, sizes, etc. shown in drawings attached to this specification are only used to match content disclosed in the specification and are for understanding and reading of people familiar with this technology. They are not used to limit an implementation of the disclosure. Therefore, it has no technical substantive significance. Any modification of structure, change of proportional or adjustment of size shall still fall within a scope of this disclosure without affecting an effect that the disclosure can produce and the purpose that can be achieved. At the same time, it should be noted that the terms such as “upper”, “lower”, “left”, “right”, “middle” and “one” cited in this specification are only for the convenience of description and are not used to limit the scope of the disclosure. The change or adjustment of the relative relationship should also be regarded as the applicable scope of the disclosure without substantial change in the technical content. Please refer to FIG. 1 through FIG. 4. In some embodiments, the disclosure proposes a high-pressure hose of a pressure washer. The high-pressure hose is a hose that can withstand pressure. This hose is used to transport liquid and can be specifically used in a field of pressure washers for garden irrigation. For example, the high-pressure hose in the disclosure may be mounted on a pressure washer, and manual or mechanical methods may be used to supplement the soil moisture in the garden and green space through different irrigation forms to meet water needs of plants. The hose body in the disclosure has strong flexibility and relatively small bending radius. Moreover, while the hose body has strong flexibility, it also has strong blast resistance, which enhances an operator's experience. The high-pressure hose of the pressure washer of the disclosure has high lasting strength, high oxidation resistance and corrosion resistance, good organizational stability and sufficient strength, hardness, wear resistance and impact toughness. The following will be described in detail through specific examples.

Please refer to FIG. 1 and FIG. 2. In some embodiments, the disclosure provides a high-pressure hose of the pressure washer, which may include an inner hose 10, an interlayer 20 and an outer hose 30. Wherein, the inner hose 10 may be made of cold-resistant PVC (polyvinyl chloride) material. Polyvinyl chloride may be synthesized from ethylene, chlorine and catalyst through a substitution reaction, and has good softness. During an irrigation process of a garden, the inner hose 10 is in a direct contact with the irrigation solution. An advantage of using the polyvinyl chloride material for the inner hose 10 is that it may ensure that the inner hose 10 may still maintain good softness under a low temperature condition. Moreover, in some garden irrigation processes, some nutrient solution needs to be added to an irrigation solution, so the inner hose 10 is made from polyvinyl chloride material. Since the polyvinyl chloride material has fire-proof and heat-resistant functions, it can still meet usage requirements.

Please refer to FIG. 2. In some embodiments, the interlayer 20 may be sleeved on an outer wall of the inner hose 10. The interlayer 20 may be made of high-strength polyester industrial filament, which may also increase an overall structural strength of high-pressure hose while ensuring a satisfactory overall softness. The outer hose 30 may be sleeved on an outer wall of the interlayer 20, and the outer hose 30 may be made of high-strength pitted and wear-resistant PVC material. During a use of the pressure washer, such as during garden irrigation, the outer hose 30 is in a direct contact with an external environment. For example, the outer hose 30 may be in contact with a body of the pressure washer, or the outer hose 30 may be in direct contact with other objects. An advantage of using polyvinyl chloride material for the outer hose 30 is that a strength of the outer hose 30 may be ensured during a contact with the external environment. Moreover, the outer hose 30 is provided with a pitted-textured structure, which may also improve user's holding feel.

Please refer to FIG. 2. In some embodiments, glue is applied between the inner hose 10 and the interlayer 20 for fixation, and glue is applied between the interlayer 20 and the outer hose 30 for fixation. Through applying glue between the inner hose 10 and the interlayer 20, and between the interlayer 20 and the outer hose 30, the inner hose 10, the interlayer 20 and the outer hose 30 form a whole. Through coating glue between the inner hose 10 and the interlayer 20, and between the interlayer 20 and the outer hose 30, the high-pressure hose forms an integral structure, thereby increasing an overall structural strength of the high-pressure hose. The inner hose 10, the interlayer 20, and the outer hose 30 have the same axis, which ensures that the inner hose 10, the interlayer 20, and the outer hose 30 may be bent simultaneously. The high-pressure hose may have a relatively small bending radius. In addition, a use of elastomers for the inner hose 10 and the outer hose 30 may enhance a softness of the high-pressure hose, achieve an effect of resisting kink, and also have a relatively small bending radius.

Please refer to FIG. 2. In some embodiments, the interlayer 20 may include a braided layer 21. An angle formed by an intersection of two strands of interwoven yarn in the braided layer 21 may be from 60° to 90°. For example, the angle between the two strands of braided yarn may be 90 degrees, which means that the two strands of braided yarn are perpendicular to each other. An advantage of arranging the two strands of braided yarn to form a certain angle is that when the high-pressure hose is bent, the inner hose 10, the interlayer 20 and the outer hose 30 will be bent. The inner hose 10, the interlayer 20 and the outer hose 30 may generate a torque when they are bent. When the two strands of braided yarn are arranged to form the certain angle, and when the interlayer 20 is bent, the two strands of braided yarn may extend along an arrangement direction of the braided yarn, which greatly reduces the torque of the braided layer. In addition, when the two braided yarn are configured to form the certain angle, it may adapt to state requirements of different directions and angles of the high-pressure hose.

Please refer to FIG. 2. In some embodiments, the interlayer 20 may include the braided layer 21 and a reinforcing yarn 22. A number of braided yarn in the braided layer 21 may be at least two strands, and the braided yarn may have a spiral structure. Two strands of braided yarn may be interlaced and woven together, and the two strands of braided yarn rotate in opposite directions to form a network-like reinforcing layer structure. The braided yarn may form a body of the braided layer 21, the braided yarn may be in a shape of a circular cylinder, and the entire braided layer 21 may be in the shape of the circular cylinder. Two strands of interwoven yarn in the braided layer 21 intersect with each other to form a continuous curved cylindrical surface of a ring body. Compared with a circular cylinder with holes, the continuous circular cylindrical surface has a better bending resistance.

Please refer to FIG. 2. In some embodiments, a number of reinforcing yarn 22 may be multiple strands, and the multiple strands of reinforcing yarn 22 may be centrally symmetrical along a longitudinal axis of the braided layer 21. For example, the number of reinforcing yarn 22 may be two strands. When the reinforcing yarn 22 is arranged along an axial direction of the braided yarn, they may suppress an elongation of the high-pressure hose when it is under a pressure, and combined with the braided layer 21 of the network structure, an overall structure of the high-pressure hose may withstand a stronger pressure.

Please refer to FIG. 2. In some embodiments, one strand of the braided yarn in the braided layer 21 may include a plurality of polyester industrial filaments. For example, one strand of the braided yarn may include 24 polyester industrial filaments. The polyester industrial filaments of one strand of the interwoven yarn are connected and intersect with the polyester industrial filaments of another strand of the interwoven yarn at 90° for braiding. The Polyester filament may be polyester fiber, the polyester fiber is commonly known as “polyester”. It is a synthetic fiber synthesized by spinning polyester formed by a condensation polymerization of organic dibasic acid and dihydric alcohol, which is a polymer compound. A best advantage of polyester fiber is that it has good wrinkle resistance and shape retention, it further has high strength and elastic recovery ability, and it is durable, wrinkle-resistant, iron-free, and non-sticky.

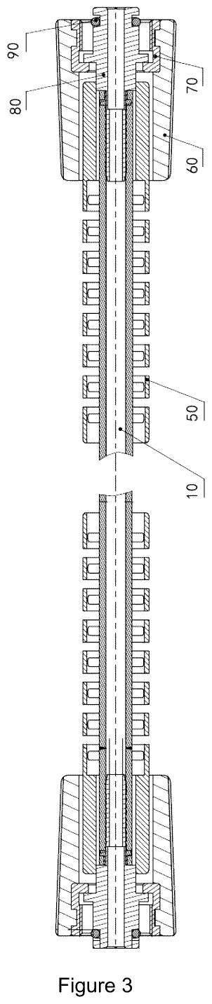

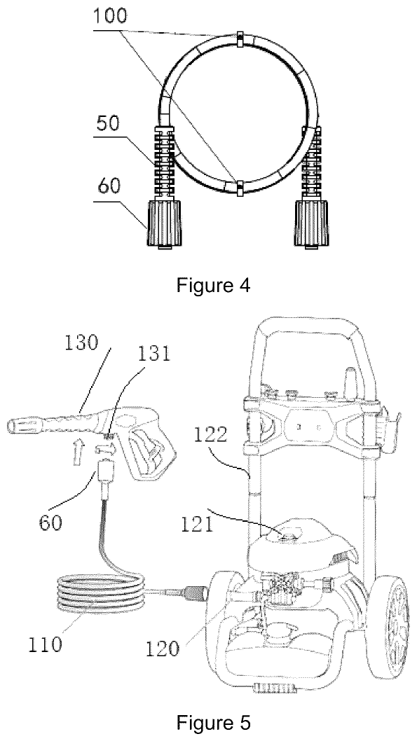

Please refer to FIG. 3 and FIG. 4. In some embodiments, the high-pressure hose of the pressure washer of the disclosure may further include a protective sleeve 50, a nut sleeve 60, a nut sleeve clamping component 70, a high-pressure hose connector 80 and a sealing ring 90. Wherein, the protective sleeve 50 may be arranged on an outer wall of the outer hose 30. For example, the protective sleeve 50 may be close to outer walls of front and tail ends of the outer hose 30, and may protect the outer hose 30, the interlayer 20 and the inner hose. The protective sleeve 50 may be in a shape of a hollow circular cylinder. The protective sleeve 50 is used for an outer insulation and protection of hose lines, and is widely used in various high-pressure hose lines. The protective sleeve 50 has characteristics of easy use, bright color, metal rust resistance, marking, bundling, flame retardant, and good insulation performance. The protective sleeve 50 may be a long hose protective sleeve, which may adapt to the bending performance of high-pressure hose. The protective sleeve 50 is mainly composed of PVC resin and additives. The additives may include heat stabilizers, lubricants, processing modifiers, impact modifiers, fillers, anti-aging agents, colorants, etc., which enables the high-pressure hose to have good performances. The nut sleeve 60 may be arranged on the outer wall of the outer hose 30. For example, the nut sleeve 60 may be arranged on the outer walls of the front and tail ends of the outer hose 30, and may protect the outer hose 30, the interlayer 20 and the inner hose 10. The nut sleeve 60 may be in the shape of the hollow circular cylinder. The nut sleeve 60 may be a precisely formed spiral coil of cold-rolled diamond-shaped stainless steel yarn, and may be an internal and external thread concentric body with high precision. The nut sleeve 60 has characteristics of high strength, high precision, and smooth surface.

Please refer to FIG. 3. In some embodiments, the high-pressure hose connector 80 may be arranged between the outer wall of the outer hose 30 and an inner wall of the nut sleeve 60. The high-pressure hose connector 80 may be sleeved on the outer walls of the front and tail ends of the outer hose 30. The two high-pressure hoses may be connected through the high-pressure hose connector 80 to extend a length of the high-pressure hose. A nut sleeve clamping component 70 may be arranged inside the nut sleeve 60, and the nut sleeve clamping component 70 may be in contact with the nut sleeve 60 and the high-pressure hose connector 80 respectively. The nut sleeve 60 may play a role in limiting and fixing the high-pressure hose connector 80, and the nut sleeve clamping component 70 may further play a role in fixing the high-pressure hose connector 80, and may lock the high-pressure hose connector 80 on the outer walls of the front and tail ends of the outer hose 30. The nut sleeve clamping component 70 is a clamping component provided with internal threads and knurling or other patterns on its outside. It may be embedded in the nut sleeve 60 to act as an effective thread on the nut sleeve 60. The nut sleeve clamping component 70 may be made from copper-plated aluminum material.

Please refer to FIG. 3. In some embodiments, the sealing ring 90 may be arranged on an outer wall of the high-pressure hose connector 80. The sealing ring 90 may be arranged between an inner wall of the nut sleeve clamping component 70 and the outer wall of the high-pressure hose connector 80. The high-pressure hose connector 80 may be plated with white zinc. The sealing ring 90 has a good sealing performance within a working pressure and a certain temperature range, and can automatically improve the sealing performance as the pressure increases. The sealing ring 90 has strong corrosion resistance, is not easy to age, and has a long duration life. It further has good wear resistance, and can automatically compensate to a certain extent after wear. The sealing ring 90 has a simple structure and is easy to use and maintain, so that the sealing ring 90 has a longer duration life. The sealing ring 90 may protect the high-pressure hose connector 80 and prevent direct contact with the high-pressure hose connector 80 from external stains and water vapor, thereby solving a problem that the high-pressure hose connector 80 is prone to corrosion and rust. A contact surface between the sealing ring 90 and the high-pressure hose connector 80 may be coated with an appropriate amount of lubricating oil, which may further solve a problem of the sealing ring 90 and the high-pressure hose connector 80 sticking together. Lubricating oil is a liquid or semi-solid lubricant used on various types of mechanical equipment to reduce friction and protect machinery and workpieces. It mainly plays functions of lubrication, auxiliary cooling, rust prevention, cleaning, sealing and buffering. The sealing ring 90 may be an O-type sealing ring, which matches an appearance of the high-pressure hose connector 80 and may reduce friction and wear caused by a contact between the high-pressure hose connector 80 and the sealing ring 90.

Please refer to FIG. 3. The protective sleeve 50, the nut sleeve 60, the nut sleeve clamping component 70, the high-pressure hose connector 80 and the sealing ring 90 may form a set and may be mounted on a first end of the outer hose 30. A second end of the outer hose 30 may be mounted with another set. A minimum diameter of the inner hose 10 may be 3.3 mm, and a maximum diameter of the outer hose 30 may be 10.5 mm, which means that a diameter of the inner hose 10 is defined as y1, 3.3 mm≤y1<10.5 mm, and a diameter of the outer hose 30 is defined as y2, 3.3 mm<y2≤10.5 mm, and y1<y2. An inner diameter of the sealing ring 90 may be 3.85 mm, a diameter of the sealing ring 90 may be 3.95 mm, and a height of the sealing ring 90 may be from 3 mm to 3.2 mm. A diameter of the nut sleeve clamping component 70 may be from 9.6 mm to 9.7 mm. After the protective sleeve 50, the nut sleeve 60, the nut sleeve clamping component 70, the high-pressure hose connector 80 and the sealing ring 90 are assembled, the protective sleeve 50 may withstand at least 50 N of tensile force without loosening.

Please refer to FIG. 4. In some embodiments, the protective sleeve 50 and the nut sleeve 60 may be arranged in contact with the outer wall of the outer hose 30, and the protective sleeve 50 and the nut sleeve 60 may be located at the front and tail ends of the outer hose 30. The high-pressure hose of the pressure washer may further include a strap 100, and the strap 100 may be arranged on the outer wall of the outer hose 30. A number of the straps 100 may be at least one. When the number of the straps 100 is one, the straps 100 may be located at a middle position of the outer hose. When the number of straps 100 is two, the two straps 100 may be symmetrically arranged on the outer hose 30. An advantage of arranging the two straps 100 symmetrically on the outer hose 30 is that the outer hose 30 may be tied at two different positions, which avoids the outer hose 30 being prone to slipping when only one position is tied. The strap 100 is a long strip made of leather, cloth or thread, and is used to tie the outer hose 30. The high-pressure hose may be stored conveniently after being rolled up. In order to ensure that the high-pressure hose can occupy a smaller space, and also consider that the bending resistance of the high-pressure hose will not decrease during a rolling process of the high-pressure hose, in the disclosure, a diameter of a ring body formed by the high-pressure hose after being rolled up may be from 200 mm to 250 mm. In this disclosure, a burst test pressure reaches 9300 psi (Pounds per square inch, which is a pressure measurement unit), P refers to pound, S refers to square, and I refers to inches. When a burst pressure of the hose body reaches 9,300 psi, a bending radius of the high-pressure hose using this technical solution is only from 50% to 70% of that of an ordinary high-pressure hose. Printing may be performed on the outer wall of the high-pressure hose, and information such as manufacturer information, production date, and production specifications may be printed.

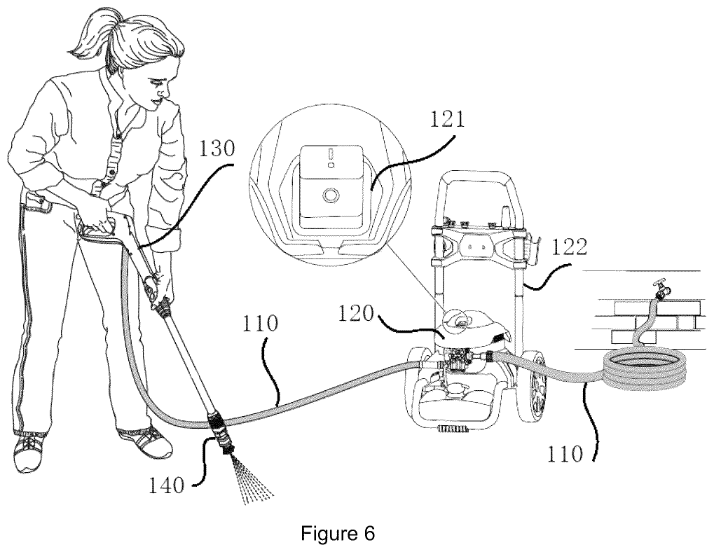

Please refer to FIG. 5 and FIG. 6. The disclosure may further provide a high-pressure hose of the pressure washer, which may include at least two high-pressure hoses 110, a power assembly 120, a working head 130 and a nozzle 140. Wherein, the power assembly 120 may be provided with an input port and an output port, and the input port and the output port may be connected with the high-pressure hoses 110 respectively. The high-pressure hose 110 corresponding to the input port may be connected with a water supply pipe. For example, the high-pressure hose 110 corresponding to the input port may be connected with a faucet. The high-pressure hose 110 corresponding to the output port may be connected with the working head 130, and the working head 130 may be connected with the nozzle 140. The user controls the working head 130 to adjust a water outlet speed and water output amount at the nozzle 140.

Please refer to FIG. 5 and FIG. 6. In some embodiments, two ends of one of the high-pressure hoses 110 are respectively connected with the output port of the power assembly 120 and the working head 130 through the high-pressure hose connectors 80. The working head 130 may be provided with an external thread port 131, and the high-pressure hose connectors 80 are rotatably connected with the output port of the power assembly 120 and the working head 130. Two end of another high-pressure hose 110 are respectively connected with the input port of the power assembly and the water supply hose through the high-pressure hose connectors 80. The power assembly 120 may be provided with a tow hook 121, which may facilitate a transportation of the pressure washer through towing. The power assembly 120 may further be arranged on a trolley structure 122. Through mounting the power assembly 120 on the trolley structure 122, it is convenient for the user to move the pressure washer during work, which increases the user's experience.

To sum up, the disclosure provides the high-pressure hose of the pressure washer. The high-pressure hose of the disclosure has both good pressure-bearing performance and good softness, which improves the user's experience. The high-pressure hose of this disclosure is also non-toxic, environmentally friendly, physiologically inert, resistant to ultraviolet rays, resistant to ozone, resistant to high and low temperature (ranging from −80° C. to 300° C.), and has high transparency, strong resilience, permanent compression resistance without deformation, oil resistance, stamping resistance, acid and alkali resistance, wear resistance, flame retardancy, high withstand voltage, low conductivity and other performances.

This specification has generally described the system and method which are helpful in understanding the details of the disclosure. In addition, various specific details have been given to provide an overall understanding of the embodiments of the disclosure. However, those skilled in the relevant art will recognize that the embodiments of the disclosure may be realized without one or more specific details, or may be implemented through using other devices, systems, accessories, methods, assemblies, materials, parts, etc. In other cases, well-known structures, materials, and/or operations are not specifically shown or described in detail to avoid confusion in various aspects of the embodiments of the disclosure. Therefore, although the disclosure has been described herein with reference to its specific embodiments, a freedom of modification, various changes and substitutions are also included in the above disclosure. And it should be understood that in some cases, without departing from the scope of the disclosure, some features of the disclosure will be adopted under the conditions without corresponding use of other features.

The above description of the illustrated embodiment of the disclosure (including content described in the abstract of the specification) is not intended to exhaustively enumerate or limit the disclosure to the precise form provided herein. Although specific embodiments of the disclosure and examples of the disclosure are described herein for illustrative purposes only, as those skilled in the art recognize and understand, various equivalent modifications are possible within the scope of the disclosure. As pointed out, these modifications may be made to the disclosure according to the above description of the embodiments of the disclosure, and these modifications will be within the scope of the disclosure.

What is claimed is:

1. A high-pressure hose of a pressure washer, comprising:
an inner hose, defining a fluid flow passage;
an outer hose, covering the inner hose; and
an interlayer, arranged between the inner hose and the outer hose, the interlayer at least comprising a braided layer, the braided layer provided with a latticework of interwoven yarn to be a cylindrical structure to cover an outer wall of the inner hose.

2. The high-pressure hose of a pressure washer according to claim 1, wherein
the interwoven yarn intersect with each other to form an angle, and the angle is from 60° to 90°.

3. The high-pressure hose of a pressure washer according to claim 1, wherein
the interwoven yarn in the braided layer intersect with each other to form a ring body, and the cylindrical surface of the ring body is a continuous curved surface.

4. The high-pressure hose of a pressure washer according to claim 1, wherein
the interlayer further comprises at least two strands of reinforcing yarn, and the two strands of reinforcing yarn are centrally symmetrically arranged along a longitudinal axis of the inner hose.

5. The high-pressure hose of a pressure washer according to claim 1, wherein
the interlayer is fixedly connected with the inner hose and the outer hose respectively.

6. The high-pressure hose of a pressure washer according to claim 1, wherein
the inner hose and the outer hose are made of PVC, and the braided layer is made of high-strength polyester industrial filament.

7. The high-pressure hose of a pressure washer according to claim 1, wherein
a diameter of the braided layer is defined as y3, a diameter of the inner hose is defined as y1, and a diameter of the outer hose is defined as y2, wherein, 3.3 mm≤y1<10.5 mm, 3.3 mm<y2≤10.5 mm, and y1<y3<y2.

8. The high-pressure hose of a pressure washer according to claim 1, wherein
the high-pressure hose of a pressure washer further comprises:
a high-pressure hose connector, connected to two ends of the outer hose;
a nut sleeve clamping component, sleeved on an outer wall of the high-pressure hose connector; and
a nut sleeve, sleeved on the nut sleeve clamping component and an outer wall of the outer hose.

9. The high-pressure hose of a pressure washer according to claim 1, further comprising at least two straps, wherein the straps are connected to the outer hose.

10. A pressure washer, comprising:
a power assembly, provided with an input port and an output port;
at least two high-pressure hoses, respectively connected with the input port and output port of the power assembly, each high-pressure hose comprising:
an inner hose, defining a fluid flow passage,
an outer hose, covering the inner hose, and
an interlayer, arranged between the inner hose and the outer hose, the interlayer at least comprising a braided layer and being sleeved on an outer wall of the inner hose, and the braided layer comprising at least two braided yarn,
wherein, the outer hose is sleeved on an outer wall of the braided layer, the two braided yarn are spiral-shaped and rotate in opposite directions, and the two interwoven yarn are configured to intersect with each other to form a circular cylinder network structure and cover the outer wall of the inner hose;
a working head, connected with the high-pressure hose which is connected with the output port; and
a nozzle, connected to the working head.
